(19) United States
(12) Patent Application Publication
(10) Pub. No.: US 2005/0241727 A1
(43) Pub. Date: Nov. 3, 2005

(54) Vented Funnel

(76) Inventors: Michael J. Kosmyna, Toledo, OH (US); Ralph A. Wisniewski, Toledo, OH (US)

Correspondence Address: DINSMORE & SHOHL LLP, ONE DAYTON CENTRE, ONE SOUTH MAIN STREET, SUITE 1300, DAYTON, OH, 45402-2023, US

(21) Appl. No.: 10/834,500

(22) Filed: Apr. 29, 2004

(51) Int. Cl. B67C 11/00

(52) U.S. Cl. 141/297

(57) ABSTRACT

A vented funnel. The vented funnel includes a funnel-shaped upper portion; and a neck extending downward from the funnel-shaped upper portion, the neck being substantially cylindrical and having a circular portion and a flat portion, the circular portion extending at least about half way around a circumference of the neck, the flat portion providing a vent in an opening of the lid to allow air to escape from a closed container. The invention also involves a method of filling a cup having a lid using the vented funnel.

### BACKGROUND OF THE INVENTION

This invention relates generally to filling a cup having a lid, and more particularly to a vented funnel for use with a cup having a lid, and to a method of filling a cup having a lid.

Refilling paint cups having lids can be a messy process. When the lid is removed to refill the cup, paint can drip off the lid onto the table, other equipment, and the user's hands. The dripped paint must be cleaned up, which generally requires the use of solvent and increases the time needed to complete the painting job.

A funnel can be used to refill the cup without removing the lid. The funnel is typically selected to fit snugly in the opening in the lid so that the funnel is stable while the paint is being added to the cup. However, when the paint is poured into the cup, there is no way for the air to escape from the inside of the cup. As a result, the paint does not flow smoothly into the cup. It flows in intermittently as air escapes in bubbles through the paint in the funnel. This increases the length of time needed to fill the cup. In addition, the paint remaining in the funnel when it is removed can drip onto the lid and the table, which must then be cleaned.

Attempts have been made to provide vented funnels. These solutions have generally involved including vent tubes in the funnel or making double walled funnels. These have the disadvantages of being complex to manufacture, and being difficult to clean.

Therefore, there is a need for a funnel to fill a cup having a lid which allows paint to flow smoothly into the cup.

### SUMMARY OF THE INVENTION

The present invention solves this need by providing a vented funnel for use with a closed container. The vented funnel includes a funnel-shaped upper portion; and a neck extending downward from the funnel-shaped upper portion, the neck being substantially cylindrical and having a circular portion and a flat portion, the circular portion extending at least about half way around a circumference of the neck, the flat portion providing a vent in an opening of the closed container to allow air to escape from the closed container.

Another aspect of the invention is a method of filling a cup having a lid. The method includes providing a funnel comprising a funnel portion and a neck, the neck being substantially cylindrical and having a circular portion and a flat portion, the circular portion extending at least about half way around a circumference of the neck, the flat portion providing a vent in an opening in the lid to allow air to escape from the inside of the cup; inserting the funnel into the opening in the lid; filling the funnel with a fluid, wherein the fluid flows into the cup through the neck, and air escapes from the cup through the vent.

### BRIEF DESCRIPTION OF THE DRAWINGS

FIG. 1 is a cross-section of one embodiment of the vented funnel of the present invention.

FIG. 2 is a bottom view of one embodiment of the neck of the present invention.

FIG. 3 is a cross-section of one embodiment of the vented funnel of the present invention connected to a cup with a lid.

### DETAILED DESCRIPTION OF THE INVENTION

Although the vented funnel of the present invention is described as being used for filling a paint cup with a lid, one of skill will recognize that it can be used with any fluid to be poured into a closed container.

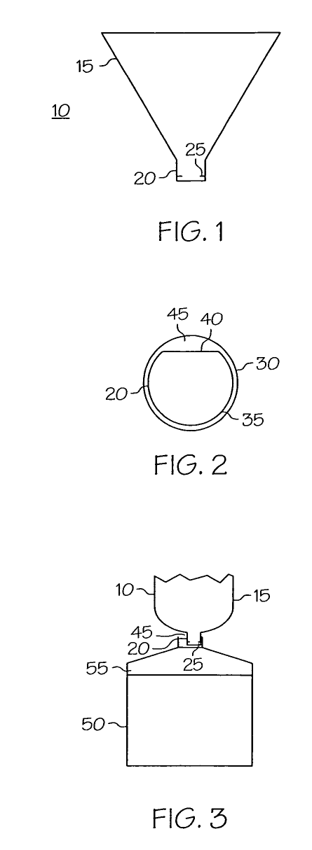

FIG. 1 shows a vented funnel 10 of the present invention. The vented funnel 10 includes a funnel-shaped upper portion 15 and a neck 20. The funnel-shaped upper portion 15 can have substantially straight sides, as shown, or the sides can be curved as shown in FIG. 3. Alternatively, the funnel-shaped upper portion can have a more complex shape, such as more than one funnel-shaped section.

The neck 20 extends downward from the funnel-shaped upper portion 15. There can optionally be a rib 25 around the inside the neck 20. The rib 25 can be slightly upward from the bottom of the neck 20. The rib 25 can extend completely around the inside of the neck, or only part of the way. The rib 25 collects paint which flows down the sides of the neck 20, reducing dripping from the funnel when the cup has been filled and the funnel is removed.

FIG. 2 shows one embodiment of the neck 20 in an opening 30 in the lid. In FIG. 2, the neck 20 has a circular portion 35. It is supported in the circular opening 30 in the lid. The circular portion 35 extends at least about half way around the circumference of the neck. The circular opening 30 in the lid is in a fluid sealing area. A substantially cylindrical neck 20 prevents damage to the opening 30 in lid. The neck 20 also has a flat portion 40 which provides a vent 45 in the opening 30 in the lid for air to escape from the cup. There would typically be one flat portion, although two or more could be used if desired.

FIG. 3 shows the vented funnel 10 of the present invention connected to a cup 50 with a lid 55. The vented funnel 10 has a curved funnel-shaped upper portion 15 and a neck 20. The neck 20 is positioned in the opening 30 in the lid 55. There is a vent 45 formed between the flat portion of the neck 20 and the opening in the lid 55. The vent 45 allows air to escape from the inside of the cup 50. When the vented funnel 10 is filled with paint, the paint flows smoothly into the cup because the air can flow out the vent 45.

The vented funnel can be made of a solvent-resistant plastic, such as polyethylene, or some other material, such as paper.

The vented funnel can be disposable, if desired. This would eliminate clean up time and save solvent. A disposable funnel must be inexpensive. One way to reduce the cost is make the vented funnel very thin. A very thin vented funnel may need a funnel-shaped support. If a funnel support is used, the vented funnel would be put into the funnel support before the vented funnel is inserted into the opening in the lid.

Alternatively, the vented funnel could be lined with a funnel liner, which could be made of paper. This could also reduce or eliminate clean up. If a funnel liner is used, it would be placed in the vented funnel before the vented funnel is filled with paint.

The vented funnel of the present invention is easy to manufacture, simple to use, and easy to clean (if needed).

While certain representative embodiments and details have been shown for purposes of illustrating the invention, it will be apparent to those skilled in the art that various changes in the apparatus and methods disclosed herein may be made without departing from the scope of the invention, which is defined in the appended claims.

1. A vented funnel for use with a closed container, the vented funnel comprising:
a funnel-shaped upper portion; and
a neck extending downward from the funnel-shaped upper portion, the neck being substantially cylindrical and having a circular portion and a flat portion, the circular portion extending at least about half way around a circumference of the neck, the flat portion providing a vent in an opening of the closed container to allow air to escape from the closed container.

2. The vented funnel of claim 1 wherein the funnel-shaped upper portion has substantially straight sides.

3. The vented funnel of claim 1 wherein the funnel-shaped upper portion has curved sides.

4. The vented funnel of claim 1 wherein the vented funnel is made of plastic.

5. The vented funnel of claim 1 further comprising a funnel support adapted to receive the vented funnel.

6. The vented funnel of claim 1 further comprising a funnel liner adapted to fit in the vented funnel.

7. The vented funnel of claim 6 wherein the funnel liner is made of a material selected from paper, or plastic.

8. The vented funnel of claim 1 further comprising a rib on the inside of the neck.

9. The vented funnel of claim 8 wherein the rib extends completely around the inside of the neck.

10. The vented funnel of claim 1 wherein there are at least two flat portions.

11. A vented funnel for use with a cup having a lid, the vented funnel comprising:
a funnel-shaped upper portion; and
a neck extending downward from the funnel-shaped upper portion, the neck being substantially cylindrical and having a circular portion and a flat portion, the circular portion extending at least about half way around a circumference of the neck, the flat portion providing a vent in an opening of the lid to allow air to escape from the cup, and the inside of the neck having a rib.

12. The vented funnel of claim 11 wherein the funnel-shaped upper portion has substantially straight sides.

13. The vented funnel of claim 11 wherein the funnel-shaped upper portion has curved sides.

14. The vented funnel of claim 11 wherein the vented funnel is made of plastic.

15. The vented funnel of claim 11 further comprising a funnel support adapted to receive the vented funnel.

16. The vented funnel of claim 1 further comprising a funnel liner adapted to fit in the vented funnel.

17. The vented funnel of claim 8 wherein the rib extends completely around the inside of the neck.

18. A method of filling a cup having a lid, the method comprising:
providing a vented funnel comprising a funnel portion and a neck, the neck being substantially cylindrical and having a circular portion and a flat portion, the circular portion extending at least about half way around a circumference of the neck, the flat portion providing a vent in an opening in the lid to allow air to escape from the inside of the cup;
inserting the vented funnel into the opening in the lid;
filling the vented funnel with a fluid,
wherein the fluid flows into the cup through the neck, and air escapes from the cup through the vent.

19. The method of claim 18 further comprising placing a funnel liner in the vented funnel before filling the liner with the fluid.

20. The method of claim 18 further comprising placing the funnel in a funnel support before inserting the vented funnel into the opening in the lid.
